(19) United States
(12) Patent Application Publication
(10) Pub. No.: US 2026/0204973 A1
(43) Pub. Date: Jul. 16, 2026

(54) ELECTRIC MACHINE

(71) Applicant: ZF FRIEDRICHSHAFEN AG, Friedrichshafen (DE)

(72) Inventors: Roland LINDWURM, Sennfeld (DE); Sebastian BAUMGART, Bed Bocklet (DE); Jochen WITTMANN, Burkardroth (DE); Katja WILLACKER, Wiesentheid (DE); Andreas HESLER, Sennfeld (DE); Christoph WIEDER, Küps (DE); Tobias SCHRENK, Bad Neustadt an der Saale (DE); Marcel WERNER, Schonungen (DE); Martin BOTSCH, Hattersheim am Main (DE)

(73) Assignee: ZF FRIEDRICHSHAFEN AG, Friedrichshafen (DE)

(21) Appl. No.: 19/135,508

(22) PCT Filed: Nov. 28, 2023
(86) PCT No.: PCT/EP2023/083376

§ 371 Date: Jun. 4, 2025

(30) Foreign Application Priority Data
Dec. 5, 2022 (DE) 10 2022 213 076.6

(51) Int. Cl. H02K 3/50; H02K 3/48; H02K 11/33

(52) U.S. Cl. CPC H02K 3/50; H02K 3/48; H02K 11/33; H02K 2203/09

(57) ABSTRACT

Electric machine, particularly electric machine for a motor vehicle, having a plurality of phases and a plurality of phase terminals which are connected to the individual phases for contacting the electric machine with a control device, particularly an inverter, and a star conductor. The star conductor and the phase terminals are arranged at different circumferential positions with reference to a longitudinal axis of the electric machine.

### PRIORITY CLAIM

This is a U.S. national stage of application No. PCT/EP2023/083376 filed on 28 Nov. 2023. Priority is claimed on German Application No. 10 2022 213 076.6, Filed 5 Dec. 2022, the content of which is incorporated here by reference.

### BACKGROUND OF THE INVENTION

### 1. Field of the Invention

The disclosure is directed to an electric machine, particularly an electric machine for a motor vehicle, comprising a plurality of phases and a plurality of phase terminals which are connected to the individual phases for contacting the electric machine with a control device, particularly an inverter, and to a star conductor.

### 2. Description of the Related Art

Electric machines, for example, for use as drive devices in a motor vehicle, having a plurality of phases and a plurality of phase terminals connected to the individual phases for contacting the electric machine with a control device are known in principle from the prior art. With regard to the control device, for example, an inverter, currents can be introduced into the electric machines via the phase terminals.

Because of increasing power density requirements and to make optimal use of available installation space, the phase terminals can be arranged outside of the stator space of the electric machine. In so doing, when the electric machine is connected in the form of a star connection, the star conductor is usually installed in a module with the above-described phase terminals and arranged in the installation space. Such a connection module is subsequently arranged at a suitable location in the installation space, for example, in a transmission device or in another installation space of the motor vehicle. However, as a result, the entire connection module requires a certain installation space that is taken up contiguously.

### SUMMARY OF THE INVENTION

It is an object of the invention to provide an electric machine which is improved over the latter and in which, in particular, there is greater flexibility with respect to the use of installation space.

As has been described, an embodiment of the invention is directed to an electric machine, particularly an electric machine for a motor vehicle, which is formed, for example, as a drive device or traction drive, particularly as an electric axle drive, for the motor vehicle. The electric machine has a plurality of phases, for example, three phases u, v, w, and a plurality of phase terminals to connect the individual phases, i.e., to a control device, particularly an inverter, in order to supply the electric machine with electrical energy. A star connection is provided in the electric machine so that a star conductor is formed at the star point of the interconnection. The invention is based on the insight that the star conductor and the phase terminals are arranged at different circumferential positions with reference to a longitudinal axis of the electric machine.

Accordingly, in contrast to the prior art described above, it is possible to arrange the star conductor and the phase terminals independently from one another in the installation space. For example, as was described above, the phase terminals can form a module in which they are arranged, for example, fixedly positioned relative to one another in defined relative positions. The star conductor can in turn be arranged independently from the phase terminals in another position so that less contiguous installation space needs to be taken up for the star conductor and the phase terminals but, instead, the latter can be arranged more flexibly and independently from one another.

In other words, a contiguous portion of the installation space is possibly sufficient only for the phase terminals or the star conductor so that the phase terminals and star conductor can be arranged in different circumferential positions, i.e., different portions of the installation space, and need take up less installation space on the whole, for example, in radial direction, than if the star conductor and phase terminals were combined in a module and fixedly positioned relative to one another. This allows more flexibility in the use of the available installation space. The longitudinal axis of the electric machine can be an axis of symmetry of the electric machine in particular, particularly a rotational axis of the rotor. The longitudinal axis extends axially through the stator space or rotor space. The star conductor may also be referred to as “neutral conductor”.

According to a further configuration of the electric machine, the star conductor and the phase terminals can be arranged at the same radial position or at different radial positions particularly with respect to a rotational axis of the electric machine. As has been described, in the suggested electric machine it is possible in principle to position the star conductor and phase terminals independently from one another in the electric machine. According to the described configuration, it can be provided, for one, that the phase terminals and the star conductor are arranged at different circumferential positions and at the same radial position or are arranged at different circumferential positions and at different radial positions.

By “circumferential position” is meant the position of the star conductor or phase terminals in rotational direction around a longitudinal axis of the electric machine, for example, the rotational axis of the electric machine. By “radial position” is meant in particular the distance from the rotational axis. The arrangement of the star conductor and phase terminals at different circumferential positions and, selectively, at the same radial position or at different radial positions results in a high flexibility with respect to the arrangement of the component parts of the electric machine so that the available installation space can be used in a particularly flexible manner.

In a further development of the electric machine, a protective cap can be provided which at least partially surrounds the star conductor. The protective cap may be produced from a plastic, for example. The protective cap can aid in positioning the star conductor of the electric machine on the one hand and can bring about an insulation of, or additionally reinforce, the star conductor with respect to other components of the electric machine on the other hand. By “star conductor” is meant in particular a connection portion, i.e., an extended conducting portion constituting the star point at which the individual phases are connected to one another. The protective cap surrounds the star conductor at least partially, especially completely, so that the star conductor is protected against external influences or other conductive elements by the protective cap. Accordingly, the star conductor is surrounded by the protective cap in such a way that the star conductor cannot reach other conductive elements of the electric machine but rather is protected from such elements by the protective cap.

As was described above, the protective cap can also contribute to the positioning of the star conductor or can bring about a positioning of the star conductor. According to one configuration, the protective cap can be formed to support the star conductor in a defined position in a housing of the electric machine. For example, it may be provided that, rather than fixedly connecting the star conductor to the housing, the protective cap brings about a “floating” support of the star conductor in which the protective cap positions the star conductor in a defined manner yet allows slight movements. In particular, this makes it possible to realize a vibrational decoupling of the star conductor from the housing so that vibrations of the housing can be damped by the protective cap. In other words, the housing can vibrate relative to the protective cap, but the vibrations are not transferred directly to the star conductor from the protective cap but rather damped, as the case may be. Further, as has been described, the protective cap brings about an extensive electrical insulation of the star conductor inside of the housing. Further, the bearing support of the star conductor in the defined position ensures that air gaps and creepage distances are maintained.

According to a further configuration of the electric machine, the protective cap can have an axial stop which prevents an unintended disengagement of the protective cap. “Axial direction” of the star conductor or protective cap is the direction in which the protective cap is mounted on or applied to the star conductor. “Axial direction” can also be understood as that direction which is predetermined by the free end of the star conductor or by the free ends of the star conductor or that direction in which are pointed the free ends of the wires of the star conductor which are connected to one another via the star conductor. The axial stop can be an extension of the protective cap, for example. The axial stop prevents the protective cap against unintended disengagement from the star conductor in the available installation space. In other words, the axial stop is selected in such a way that there is a defined gap between the axial stop and an inner wall of the housing of the electric machine, but, in an assembled state, the gap remains such that the available gap is not sufficient for the protective cap to disengage even in case the protective cap undergoes a movement to disengage from the protective cap. The axial stop creates a defined air gap and/or creepage distance inside of the housing which is contributes to insulating the star conductor.

In a further development of the electric machine, the protective cap has at least one catch element, particularly two opposing catch hooks, which catch element is formed to catch the protective cap at the star conductor. The catch hooks or catch elements can also be referred to or regarded as clamping hooks or clips. In the installed state of the star conductor, two catch elements can be provided at opposing sides in circumferential direction of the star conductor. In particular, the protective cap can be mounted on the star conductor from the direction of the free ends of the wires which are connected via the star conductor. In so doing, the star conductor forms a corresponding catch surface for each catch element at which the catch element can snap in or catch. The catch element prevents unintentional disengagement of the protective cap. Particularly in cooperation with the previously described axial stop, it is ensured that an unintended disengagement of the protective cap cannot occur even when a catch element is impaired, for example, due to aging of the catch element occurring over the lifetime of the electric machine.

Further, the protective cap can have at least one spacer element which is formed to position the star conductor in radial direction. The spacer element can be a wing which projects opposite an outer surface of the protective cap and which contacts an inner surface of the housing of the electric machine. In particular, two spacer elements opposing one another in radial direction of the electric machine can be provided so that the star conductor is positioned in a defined manner in radial direction via the protective cap. The spacer elements maintain a defined spacing of the protective cap inside of the housing in radial direction so that the star conductor which is protected by the protective cap is also positioned in a defined manner in the housing of the electric machine. In particular, it can be provided that the spacer elements are elastically deformable in a defined manner so that a decoupling of vibrations relative to the housing of the electric machine also results via the spacer elements. Further, the spacer elements can be formed to damp occurring vibrations particularly because of their elastic construction and deformability.

In addition to the electric machine, the invention is directed to an electric axle drive, particularly for a motor vehicle, comprising an inverter and an electric machine described above. The inverter and the electric machine can form an electric arrangement for an electric axle drive. The inverter and electric machine can be connected to one another via the phase terminals or power connections. The invention is further directed to a motor vehicle comprising an above-described electric machine and/or an above-described electric axle drive. In addition, the invention is directed to a method for producing an electric machine, particularly an electric machine for a motor vehicle, comprising a plurality of phases and a plurality of phase terminals connected to the individual phases for contacting the electric machine with a control device, particularly an inverter, and to a star conductor, the star conductor and the phase terminals being arranged at different circumferential positions with reference to a longitudinal axis of the electric machine.

All of the advantages, details and features which have been described with respect to the electric machine are fully transferable to the electric axle drive, the motor vehicle and the method.

### BRIEF DESCRIPTION OF THE DRAWINGS

The disclosed embodiments will be described in the following based on examples referring to the drawings. The drawings are schematic representations and show:

FIG. 1 is a schematic section of an electric machine viewed radially;

FIG. 2 is a perspective schematic section of the electric machine from FIG. 1;

FIG. 3 is a schematic section of the electric machine from FIGS. 1 and 2 viewed axially;

FIG. 4 is a schematic section of a star conductor of the electric machine from FIGS. 1-3; and

FIG. 5 is a schematic sectional view of the electric machine from FIGS. 1-4.

### DETAILED DESCRIPTION OF THE DISCLOSED EMBODIMENTS

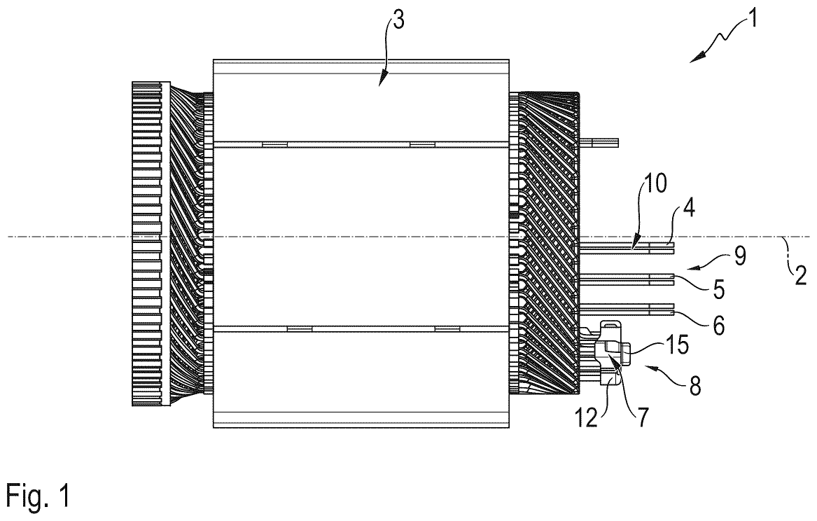

FIG. 1 shows a schematic view of an electric machine 1 viewed radially, i.e., from the outside in direction of a longitudinal axis 2, for example, a rotational axis of the rotor of the electric machine 1. As will be seen, the electric machine 1 has a plurality of conductors guided through a stator 3 of the electric machine 1 which are referred to or considered as hairpins or which can be constructed as such. The individual conductors are associated with individual phases-three phases in this embodiment example which are guided out of the stator 3 at phase terminals 4-6. The phase terminals 4-6 can be connected, for example, to a control device, not shown in more detail, particularly an inverter.

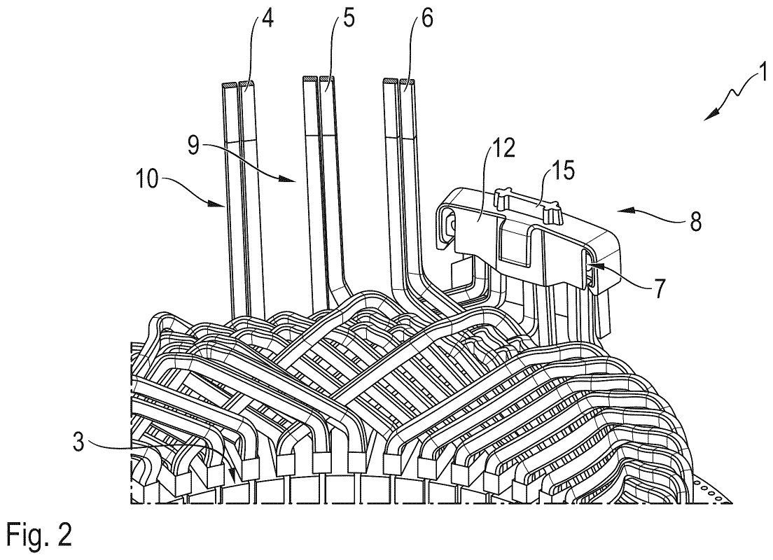

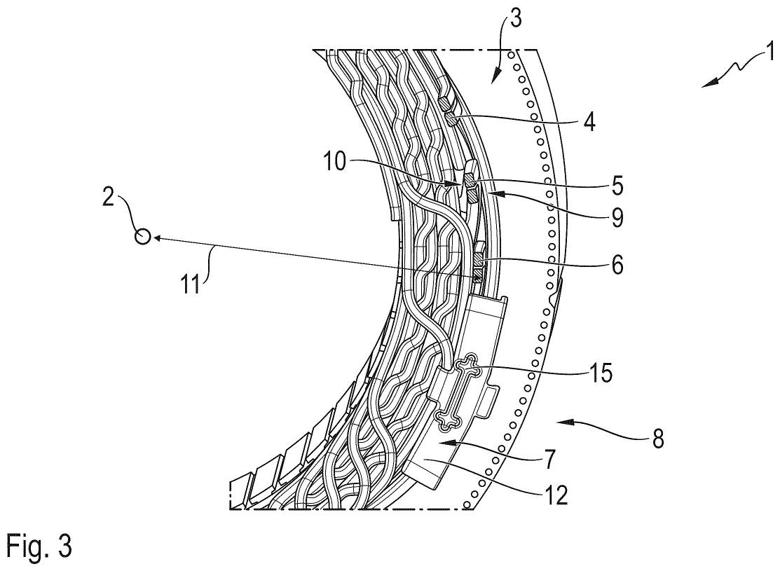

FIG. 1 further shows a star conductor 7 which forms the star point of the star connection of the electric machine 1. As can be gathered from FIGS. 1-3, the phase terminals 4-6 and the star conductor 7 are arranged at different circumferential positions 8, 9. The phase terminals 4-6 can be combined to form a module 10, i.e., for example, arranged in a defined relative position with respect to one another. For example, the module 10 can be connected to the control device in order to contact the phase terminals 4-6 with the control device.

Arranging the star conductor 7 and the phase terminals 4-6 independently in circumferential direction results in an extensive flexibility in the use of the available installation space. Conventionally formed modules 10 in which the phase terminals 4 6 and the star conductor 7 are combined require a comparatively appreciably larger contiguous installation space particularly because the creepage distance and air gaps already defined between the star conductor 7 and the phase terminals 4-6 must be maintained. As a result of the arrangement of the star conductor 7 at a circumferential position 8 different than the phase terminals 4-6 at circumferential position 9, installation space is saved in radial direction on the one hand and, on the other hand, the star conductor 7 is at the same time spaced far enough from the phase terminals 4-6 that defined creepage distances and air gaps are maintained.

As can further be seen from FIGS. 1-3, the star conductor 7 and the phase terminals 4-6 are arranged in the same radial position 11, i.e., the distance in radial direction from the longitudinal axis 2 is the same for the star conductor 7 and the phase terminals 4-6. Alternatively, it is also possible to arrange the star conductor 7 and the phase terminals 4-6 at different respective radial positions 11. As a result, the star conductor 7 and the phase terminals 4-6 are arranged at different circumferential positions 8, 9 on the one hand and are simultaneously arranged at different radial positions or the same radial position 11.

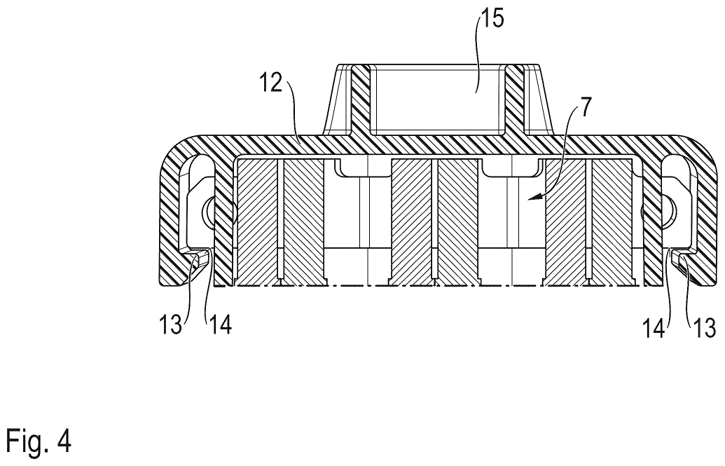

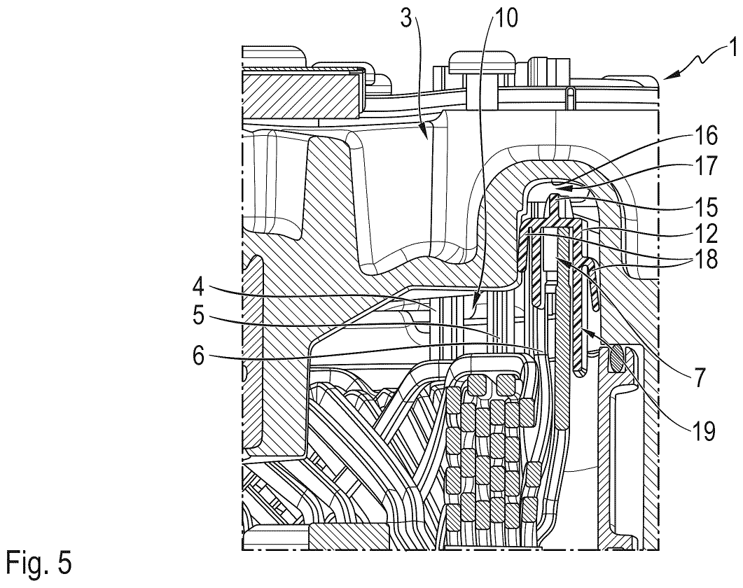

As can further be appreciated from the drawings, the star conductor 7 has a protective cap 12 which at least partially surrounds the star conductor 7. In the depicted embodiment examples, the protective cap 12 protects the star conductor 7 against contact with other component parts of the electric machine 1. In particular, as will be described in the following, the protective cap 12 positions and insulates the star conductor 7 with respect to the surroundings thereof. As is best shown in FIGS. 4, 5, the protective cap 12 is “mounted” on the star conductor 7 in direction of the free ends of the star conductor 7. The protective cap 12 provides catch elements 13 for this purpose, particularly catch hooks, which catch at a catch surface 14 of the star conductor 7. This prevents an unintentional disengagement of the protective cap 12 from the star conductor 7.

Further, the protective cap 12 has an axial stop 15 which also prevents an unintentional disengagement of the protective cap 12 from the star conductor 7. It is shown in FIG. 5 in particular that a gap 17 is formed between an inner surface 16 of a housing of the electric machine 1 and the axial stop 15 in the assembled state. The axial stop 15 and the gap 17 are selected in such a way that defined air gaps and creepage distances are maintained, but an unintended disengagement of the protective cap 12 is prevented, since the gap 17 is not sufficient for the distance of the protective cap 12 from the star conductor 7 to be such that a disengagement of the protective cap 12 would be possible, for example, in case of a failure of the catch element 13.

As was described in the introductory part, the protective cap 12, apart from insulating the star conductor 7, is also formed to position the star conductor 7. To this end, the protective cap 12 in the depicted embodiment examples has spacer elements 18 which project from an outer surface 19 of the protective cap 12. The spacer elements 18 can be understood as “wings” which extend away from a base body of the protective cap 12. As a result of the spacer elements 18, the protective cap 12 and, therefore, the star conductor 7 are “floatingly” mounted in the housing of the electric machine 1, particularly relative to the inner surface 16. In other words, a defined movement of the star conductor 7 inside of the housing of the electric machine 1 is possible. A decoupling of vibrations from the star conductor 7 is achieved in this way so that a direct transfer of vibrations from the housing of the electric machine 1 to the star conductor 7 is decoupled.

The advantages, details and features shown in the individual embodiment examples may be combined with one another, interchanged with one another and transferred to one another as needed. In particular, the electric machine 1 may be a component part of an electric drive axle or of an electric axle drive which can in turn be arranged in a motor vehicle. Such a motor vehicle can accordingly have an electric drive axle having an electric machine 1 as drive device.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An electric machine for a motor vehicle, comprising a plurality of individual phases and a plurality of phase terminals which are connected to the individual phases for contacting the electric machine with an inverter, and a star conductor, wherein the star conductor and the phase terminals are arranged at different circumferential positions with reference to a longitudinal axis of the electric machine.

2. The electric machine according to claim 1, wherein the star conductor and the phase terminals are arranged at the same radial position or at different radial positions particularly with respect to a rotational axis of the electric machine.

3. The electric machine according to claim 1, further comprising a protective cap which at least partially surrounds the star conductor.

4. The electric machine according to claim 3 wherein the protective cap is formed to support the star conductor in a defined position in a housing of the electric machine.

5. The electric machine according to claim 3, wherein the protective cap has an axial stop which prevents an unintended disengagement of the protective cap.

6. The electric machine according to claim 3, wherein the protective cap has at least one catch element formed to catch the protective cap at the star conductor.

7. The electric machine according to claim 3, wherein the protective cap has at least one spacer element formed to position the star conductor in radial direction.

8. An electric axle drive for a motor vehicle, comprising an inverter and an electric machine according to claim 1.

9. A motor vehicle comprising an electric machine according to claim 1.

10. A method for producing an electric machine for a motor vehicle, comprising a plurality of phases and a plurality of phase terminals connected to the individual phases for contacting the electric machine with an inverter, and a star conductor, wherein the star conductor and the phase terminals are arranged at different circumferential positions with reference to a longitudinal axis of the electric machine.

11. A motor vehicle comprising an electric axle drive according to claim 8.

12. The electric machine according to claim 3, wherein the protective cap has two opposing catch hooks formed to catch the protective cap at the star conductor.

13. An electric machine, comprising a plurality of individual phases and a plurality of phase terminals which are connected to the individual phases for contacting the electric machine with an inverter, and a star conductor, wherein the star conductor and the phase terminals are arranged at different circumferential positions with reference to a longitudinal axis of the electric machine.
